(19) United States
(12) Patent Application Publication
(10) Pub. No.: US 2006/0258333 A1
(43) Pub. Date: Nov. 16, 2006

(54) METHOD FOR BACKING UP DATA STORED IN A MOBILE ELECTRONIC DEVICE

(76) Inventors: Hsueh-Chang Yang, Taipei City (TW); Chih-Chia Tsai, Tai-Chung Hsien (TW)

Correspondence Address: NORTH AMERICA INTELLECTUAL PROPERTY CORPORATION, P.O. BOX 506, MERRIFIELD, VA, 22116, US

(21) Appl. No.: 11/382,921

(22) Filed: May 11, 2006

(30) Foreign Application Priority Data
May 12, 2005 (TW) 094115414

(51) Int. Cl. H04L 12/58

(52) U.S. Cl. 455/412.1

(57) ABSTRACT

A method for backing up data stored in a mobile electronic device is disclosed. The claimed method includes checking a plurality of data sets stored in the mobile electronic device according to a first predetermined rule to determine whether the data sets have been backed up into a remote storage unit; and processing at least one of the data sets that has not been backed up into the remote storage unit according to a second predetermined rule. The method of the present invention improves the security of mobile electronic devices without requiring users to perform complicated operations manually.

### BACKGROUND OF THE INVENTION

1. Field of the Invention

The present invention relates to a method for backing up data stored in a mobile electronic device to ensure the security of the data stored in the mobile electronic device.

2. Description of the Prior Art

Mobile electronic devices are highly sophisticated electronic products, whose functions are becoming increasingly powerful. In addition to communications, their most common functions include receiving/sending messages and utilizing address books to store telephone numbers so that they do not need to be memorized by users. A mobile electronic device usually contains a large amount of personal data, including messages, contact information (i.e. telephone numbers) and even memorandums. However, if the mobile electronic device is lost or part of the memory is broken, the security of a user's personal data cannot be guaranteed and the personal data stored in the mobile phone may be stolen or violated.

According to the prior art, the mobile electronic device is connected to a personal computer by wireless means, e.g. using an infrared ray transmission device, or by wired means, such that the personal data stored in the mobile electronic device can be regularly backed up into the personal computer every predetermined period of time. Current technologies for connecting a mobile electronic device with an Internet network, such as GPRS technology, are becoming increasingly popular. Therefore, mobile electronic devices can be connected to the Internet network by wireless means, which is more convenient for uploading data that is going to be backed up. However, according to the prior art, the user still needs to manually select which data will be backed up, back up the selected data, and upload the selected data, thereby expending considerable time and effort. In addition, if a situation occurs in which the mobile electronic device is lost and the user has not backed up the personal data, it will cause the user substantial difficulties.

### SUMMARY OF THE INVENTION

One of the objectives of the claimed invention is therefore to provide a method for guaranteeing the security of data. The method comprises storing data sets stored in a mobile electronic device. The method also comprises the mobile electronic device checking whether all data sets stored in the mobile electronic device have been backed up and backing up any data set that has not already been backed up into a remote storage unit, in order to ensure the security of the data stored in the mobile electronic device and to decrease the effort expended by users. The method according to the claimed invention also provides a mobile electronic device with an encryption mechanism, so that when the mobile electronic device fails to pass a security check, any data sets stored in the mobile electronic device that has not already been backed up will be encrypted and backed-up data stored in the mobile electronic device will be deleted to prevent said data sets from being leaked.

According to the claimed invention, a method for backing up data stored in a mobile electronic device is disclosed. The method comprises: checking a plurality of data sets stored in the mobile electronic device according to a first predetermined rule to determine whether the data sets have been backed up into a remote storage unit; and processing at least one of the data sets that has not been backed up into the remote storage unit according to a second predetermined rule.

In addition, the claimed invention provides another method for backing up data sets stored in a mobile electronic device. The method comprises: when the mobile electronic device is powered on and fails to pass a security check, encrypting a data set stored in the mobile electronic device according to a predetermined rule and then storing the encrypted data set into the mobile electronic device; and deleting all remaining data sets other than the encrypted data set in the mobile electronic device.

According to the present invention, the mobile electronic device automatically backs up any data set that has not already been backed up, and then uploads said data set to the remote storage unit. Without additional input from the user, the security of the data stored in the mobile electronic device can still be guaranteed. If the mobile electronic device fails to pass the security check (implying a possibility that the mobile electronic device has been stolen or misappropriated), the present invention encrypts any data set that has not been backed up and deletes the remaining backed-up data sets to protect the user's data from being leaked.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a method for backing up personal data sets stored in a mobile phone according to a first embodiment of the present invention.

FIG. 2 is a flowchart of a method for backing up personal data sets stored in a mobile phone according to a second embodiment of the present invention.

### DETAILED DESCRIPTION

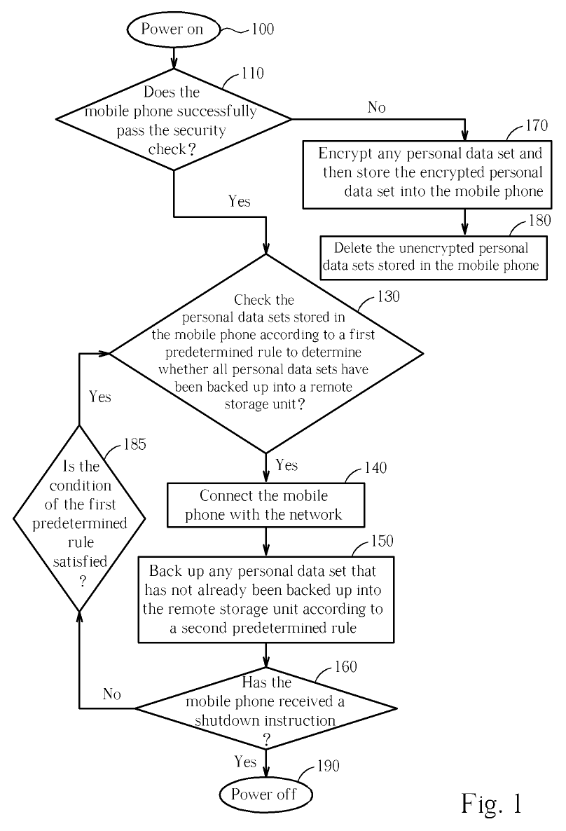

The method according to the present invention comprises checking personal data sets stored in the mobile electronic device according to a first predetermined rule to determine whether the data sets have been backed up into a remote storage unit; and processing at least one of the personal data sets according to a second predetermined rule if the personal data set has not been backed up into the remote storage unit. A mobile phone is taken as an example of a mobile electronic device utilized in a first embodiment of the present invention; however, other mobile electronic devices, such as a PDA, a laptop etc. can also be applied in the present invention. Please refer to FIG. 1. FIG. 1 is a flowchart of a method for backing up personal data sets stored in a mobile phone according to the first embodiment of the present invention.

Step 100: Power on.

Step 110: Perform a security check on the mobile phone. If the mobile phone successfully passes the security check proceed to step 130; otherwise, proceed to step 160.

Step 130: Check the personal data sets stored in the mobile phone according to a first predetermined rule to determine whether all personal data sets have been backed up into a remote storage unit.

Step 140: Connect the mobile phone with the network.

Step 150: Back up any personal data set that has not already been backed up into the remote storage unit according to a second predetermined rule.

Step 160: Has the mobile phone received a shutdown instruction? If so, proceed to step 180; otherwise, proceed to step 185.

Step 170: Encrypt any personal data set and then store the encrypted personal data into the mobile phone.

Step 180: Delete the unencrypted personal data sets stored in the mobile phone.

Step 185: If the condition of the first predetermined rule is satisfied, proceed to step 130.

Step 190: Power off.

As shown in FIG. 1, in the first embodiment of the method according to the present invention, when a user powers on the mobile phone and the mobile phone successfully passes the security check, the mobile phone provides the user with a function of automatically backing up the personal data sets into a remote storage unit. After the mobile phone is powered on and has successfully passed the security check, the method can proceed to step 130. In step 130, the mobile phone checks if any personal data set needs to be backed up. The mobile phone in step 140 is connected to the Internet network through a GPRS (General Packet Radio Services) technology. Next, in step 150, the mobile phone processes any personal data set that has not been backed up according to a second predetermined rule, wherein the second predetermined rule comprises backing up data sets that need to be backed up into a remote storage unit. The first predetermined rule in step 130 comprises checking over a predetermined period of time whether all personal data sets stored in the mobile phone have been backed up into the remote storage unit; for example, doing the above-mentioned check over a 30 minute period of time, at regular intervals. Alternatively, the first predetermined rule in step 130 can be checking at a particular predetermined time whether all personal data sets stored in the mobile phone have been backed up into the remote storage unit; for example, doing the above-mentioned check every hour, on the hour; or doing the above-mentioned check at a specific time set by the user. The first predetermined rule also can be checking whether all personal data sets stored in the mobile phone have been backed up into the remote storage unit when a data set is added to the mobile phone. In the method according to the present invention, the mobile phone checks whether all personal data sets stored in the mobile phone have been backed up into the remote storage unit only after the mobile phone has been successfully powered on and passed the security check.

In addition to backing up the personal data sets stored in the mobile phone into the remote storage unit according to the predetermined rule after the mobile phone has successfully passed the security check, the method according to the present invention further comprises performing two steps 170 and 180 if the mobile phone fails to pass the security check. In step 170, the mobile phone encrypts any personal data set that has not been backed up and then stores the encrypted personal data set into the mobile phone. In step 180, the mobile phone deletes all remaining personal data sets other than the encrypted personal data set. In this way, if the mobile phone is stolen or misappropriated and the mobile phone fails to pass the security check, any personal data set stored in the mobile phone that has not been backed up will be encrypted, and any data set that has been backed up into the remote storage unit will be deleted. In this way, a person who steals or misappropriates the mobile phone cannot violate the private information of the mobile phone's owner. If the mobile phone's owner can retrieve the mobile phone, he/she can recover the backed-up data by accessing the remote storage unit, which contains the backed-up data. Any personal data set that has not been backed-up can be retrieved by decrypting the encrypted personal data set.

From the method according to the present invention, the first predetermined rule can also be designed to check whether all personal data sets stored in the mobile phone have been backed up into the remote storage unit when the mobile phone receives a shutdown instruction, and then to back up the personal data sets before the mobile phone is powered off. Step 130 in the first embodiment, “Check the personal data sets stored in the mobile phone according to a first predetermined rule to determine whether all personal data sets have been backed up into a remote storage unit” can be performed repeatedly, wherein different predetermined rules can be adopted according to different conditions. The present invention can also be applied for protecting personal data when a plurality of SIM cards (Subscriber Identity Module cards) are alternatively utilized in a same mobile phone, so that personal data respectively corresponding to each SIM card can be protected from inappropriate deletion.

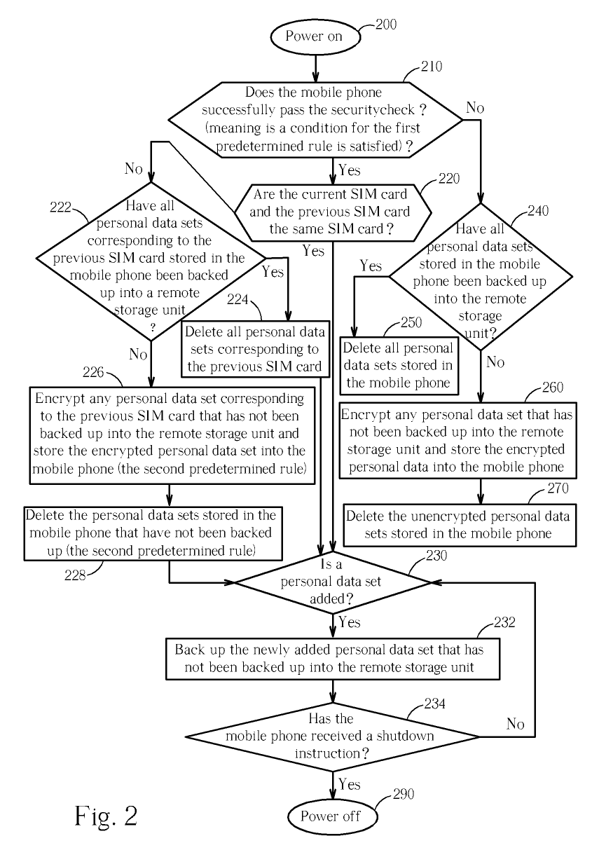

Please refer to FIG. 2. FIG. 2 is a flowchart of a method for backing up personal data sets stored in a mobile phone according to a second embodiment of the present invention, wherein the detailed illustration of steps performed in certain specific situations are included.

Step 200: Power on.

Step 210: Perform a security check on the mobile phone to check whether the mobile phone successfully passes the security check; if so (meaning a condition for the first predetermined rule is satisfied), proceed to step 220; otherwise, proceed to step 240.

Step 220: Check if the current SIM card and the previous SIM card (the SIM card utilized in the mobile phone the last time it was powered on) are the same SIM card (the first predetermined rule); if so, proceed to step 230; otherwise, proceed to step 222.

Step 222: Check if all personal data sets corresponding to the previous SIM card stored in the mobile phone has been backed up into a remote storage unit; if so, proceed to step 224; otherwise, proceed to step 226.

Step 224: Delete all personal data sets corresponding to the previous SIM card.

Step 226: Encrypt any personal data set corresponding to the previous SIM card that has not been backed up into the remote storage unit and store the encrypted personal data set into the mobile phone (the second predetermined rule).

Step 228: Delete the personal data sets stored in the mobile phone that have not been backed up (the second predetermined rule).

Step 230: If a personal data set is added, proceed to step 232.

Step 232: Back up the newly added personal data set that has not been backed up into the remote storage unit.

Step 234: Check if the mobile phone has received a shutdown instruction; if so, proceed to step 290; otherwise, proceed to step 230.

Step 240: Check whether all personal data sets stored in the mobile phone have been backed up into the remote storage unit; if so, proceed to step 250; otherwise, proceed to step 260.

Step 250: Delete all personal data sets stored in the mobile phone.

Step 260: Encrypt any personal data set that has not been backed up into the remote storage unit and store the encrypted personal data into the mobile phone.

Step 270: Delete the unencrypted personal data sets stored in the mobile phone.

Step 290: Power off.

As shown in FIG. 2, the rule adopted in the second embodiment for checking whether personal data set has been backed up is backing up a newly added personal data set that has not yet been backed up in the remote storage unit into the remote storage unit. Compared with the first embodiment shown in FIG. 1, the second embodiment shown in FIG. 2 further describes when the mobile phone in step 210 fails to pass the security check and all personal data sets have been backed up, therefore in step 250 any personal data sets stored in the mobile phone are deleted in order to protect the mobile phone owner's private information from being violated by people who steal or misappropriate the mobile phone. In addition, if the mobile phone in step 220 detects that the current SIM card is different from the previous SIM card after the mobile phone is powered on, the present invention also provides functions for encrypting the personal data set not corresponding to the current SIM card (in step 226), and deleting any unencrypted personal data set stored in the mobile phone that does not correspond to the current SIM card (the second predetermined rule). In this way, the above-mentioned function can improve the security of an individual user's private information.

As mentioned above, according to the present invention, the mobile phone can be connected to the Internet network through a GPRS technology to upload the backed-up personal data sets to a storage space of the server terminal. The present invention also allows the mobile phone to utilize a general SMS (short message service) function. In this way, as long as the short message service center (SMSC) provides the individual users with enough storage space, the present invention can upload any personal data set that needs to be backed up as messages to the SMSC.

In conclusion, the present invention provides a method for backing up personal data sets stored in a mobile electronic device. According to the present invention, the mobile phone automatically uploads any data set that has not been backed up into the remote storage unit, in order to guarantee the security of the user's personal data stored in the mobile phone. If the mobile phone fails to pass the security check (implying a possibility that the mobile phone has been stolen or misappropriated), the present invention encrypts any unencrypted data sets stored in the mobile phone and deletes the remaining backed-up data sets to protect the user's personal data from being leaked. Additionally, in a situation in which different SIM cards are alternately utilized in a same mobile phone, the present invention also provides a function of encrypting data sets not corresponding to a current SIM card in order to protect personal data stored in the same mobile phone respectively corresponding to different SIM cards from being inappropriately modified. This significantly improves security of a user's private information.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for backing up data stored in a mobile electronic device, comprising:
checking a plurality of data sets stored in the mobile electronic device according to a first predetermined rule to determine whether the data sets have been backed up into a remote storage unit; and
processing at least one of the data sets that has not been backed up into the remote storage unit according to a second predetermined rule.

2. The method of claim 1, wherein the step of checking the data sets according to the first predetermined rule comprises performing a security check on the mobile electronic device.

3. The method of claim 2, further comprising:
checking whether all data sets stored in the mobile electronic device have been backed up into the remote storage unit after the mobile electronic device has successfully passed the security check; and
if at least one data set in the electronic device has not been backed up into the remote storage unit, backing up the data set into the remote storage unit.

4. The method of claim 3, further comprising:
deleting the data set from the mobile electronic device after the data set has been backed up into the remote storage unit.

5. The method of claim 2, further comprising:
checking whether all data sets stored in the mobile electronic device have been backed up into the remote storage unit after the mobile electronic device has successfully passed the security check; and
if the mobile electronic device cannot connect to the remote storage unit while at least one data set in the mobile electronic device has not been backed up into the remote storage unit, encrypting the data set.

6. The method of claim 2, further comprising:
checking whether all data sets stored in the mobile electronic device have been backed up into the remote storage unit if the mobile electronic device fails to pass the security check; and
if the mobile electronic device cannot connect to the remote storage unit while at least one data set in the mobile electronic device has not been backed up into the remote storage unit, encrypting the data set.

7. The method of claim 6, further comprising: deleting the data set from the mobile electronic device after the data set has been backed up into the remote storage unit.

8. The method of claim 2, wherein the security check comprises checking if a different subscriber identity module card (SIM card) has been connected to the mobile electronic device; if so, checking whether all data sets of a previous SIM card stored in the mobile electronic device have been backed up into a remote storage unit corresponding to the previous SIM card.

9. The method of claim 8, further comprising: if the data set corresponding to the previous SIM card hasn't been backed up, encrypting the data set and storing the encrypted data set into the mobile electronic device.

10. The method of claim 9, further comprising: deleting unencrypted data set stored in the mobile electronic device.

11. The method of claim 1, wherein the step of checking data sets according to the first predetermined rule comprises regularly checking whether all data sets stored in the mobile electronic device have been backed up into the remote storage unit over every predetermined time interval.

12. The method of claim 1, wherein the step of checking data sets according to the first predetermined rule comprises checking whether all data sets stored in the mobile electronic device have been backed up into the remote storage unit at a predetermined time.

13. The method of claim 1, wherein the step of checking the data sets according to the first predetermined rule comprises checking whether all data sets stored in the mobile electronic device have been backed up into the remote storage unit when a data set is added to the mobile electronic device.

14. The method of claim 1, wherein the step of checking the data sets according to the first predetermined rule comprises checking whether all data sets stored in the mobile electronic device have been backed up into the remote storage unit when the mobile electronic device receives a power-off instruction.

15. The method of claim 1, wherein the step of processing the data set according to the second predetermined rule comprises uploading the data set to the remote storage unit via a wireless network.

16. The method of claim 1, wherein the step of processing the data set according to the second predetermined rule comprises uploading the data set to a short message service center (SMSC).

17. A method for backing up data sets stored in a mobile electronic device, comprising:
when the mobile electronic device is powered on and fails to pass a security check, encrypting a data set stored in the mobile electronic device according to a predetermined rule and then storing the encrypted data set into the mobile electronic device; and
deleting all remaining data sets other than the encrypted data set in the mobile electronic device.

18. The method of claim 17, wherein the step of encrypting and storing comprises:
checking whether all data sets stored in the mobile electronic device have been backed up into the remote storage unit; and
if at least one data set in the mobile electronic device has not been backed up into the remote storage unit, encrypting the data set and then storing the encrypted data set into the mobile electronic device.

19. The method of claim 17, wherein the step of encrypting and storing comprises:
encrypting all data sets stored in the mobile electronic device and storing the encrypted data sets into the mobile electronic device.
